(19) United States
(12) Patent Application Publication
(10) Pub. No.: US 2007/0294246 A1
(43) Pub. Date: Dec. 20, 2007

(54) ASSOCIATING METADATA ON A PER-USER BASIS

(75) Inventors: Christopher A. Evans, Sammamish, WA (US); David Albert, Woodinville, WA (US); David R. Parlin, Redmond, WA (US); Jordan L.K. Schwartz, Seattle, WA (US); Mark A. Nikiel, Redmond, WA (US); Tomasz S.M. Kasperkiewicz, Redmond, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/424,693

(22) Filed: Jun. 16, 2006

(51) Int. Cl. G06F 17/30

(52) U.S. Cl. 707/6

(57) ABSTRACT

Systems, methods, and computer-readable media for associating metadata with an identifier for the author thereof and for communicating metadata to one or more users having shared copies of the associated file, such communication being independent of communicating the associated file. Context is provided for each metadata value associated with a shared file as each metadata value is associated with an identifier for the author thereof. Additionally, each user of a shared file may be presented with metadata associated with a file that was not associated with the file at the time the file was shared.

### BACKGROUND

Often times files (e.g., text files, image files, and the like) have metadata associated therewith. Such metadata generally comprises one or more values. For instance, a value associated with a keyword, caption, rating, intent, textual note, audio annotation, or the like may be associated with the metadata applied to a particular file. If the author of the file shares the file subsequent to applying metadata thereto, for example, utilizing a community file sharing service or through a peer-to-peer relationship, the metadata s/he has applied to the file before sharing is also shared with each file recipient. For example, suppose user A uploads a photograph of his mother from his digital camera and applies metadata thereto in the form of the keyword “Mom”. If user A subsequently shares the photograph with users B and C, these users will be able to not only view the photograph of user A's mother but will also be able to view the keyword “Mom” in association therewith. However, unless users B and C are siblings of user A, the photograph is not a photograph of user B's nor user C's mom. Accordingly, the keyword is misdescriptive with respect to users B and C.

Shared file recipients may desire to apply metadata of their own to the shared file. For instance, suppose user B believes the photograph of user A's mother to be a particularly good photograph and accordingly applies metadata thereto in the form of the rating “5 star”. Further suppose that user C applies metadata to the file in the form of the keyword “San Diego” as user C recognizes that the photograph of user A's mother includes scenery from San Diego as well. While user B and user C both applied metadata to the same file, the metadata is stored only with their individual copies of the file. Accordingly, user B does not get the benefit of user C's identification of the photograph location, user C does not get the benefit of user's B's rating, and user A does not get the benefit of either user B's or user C's added metadata unless the photograph is again shared with all peers in the shared file relationship subsequent to applying the additional metadata.

Next suppose that user B, subsequent to adding metadata to the shared file, further shares the file with user D. User D will be able to view the photograph as well as the metadata that was associated with the file at the time the file was shared, i.e., the keyword “Mom” and the rating “5 star”. User D may further be able to ascertain from the photograph's metadata that user A was the author/originator of the photograph. However, the metadata associated with user D's copy of the file will be presented in an undifferentiated list. Accordingly, if user D does not know users A and B very well, s/he may not know if the photograph is user A's mother, as user A originated the photograph, or user B's mother, as user B shared the file with user D. Additionally, user D will not be able to ascertain whether user A or user B provided the photograph with the “5 star” rating.

### SUMMARY

Embodiments of the present invention provide systems and methods for associating metadata with an identifier for the author thereof. Embodiments of the present invention further provide systems and methods for communicating metadata to one or more users having shared copies of the associated file, such communication being independent of communicating the associated file. Utilizing the systems and methods described herein, context is provided for each metadata value associated with a shared file as each metadata value is associated with an identifier for the author thereof. Additionally, each user of a shared file may be privy to metadata associated with a file that was not associated with the file at the time it was shared.

It should be noted that this Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram showing an exemplary system architecture for associating metadata with an identifier of the author thereof and communicating metadata associated with a file among a plurality of users in accordance with an embodiment of the present invention;

FIG. 3 is a flow diagram illustrating a method in accordance with an embodiment of the present invention for associating metadata with a file on a per-user basis;

FIG. 4 is a block diagram of an exemplary data structure in accordance with an embodiment of the present invention;

FIGS. 5A and 5B are a flow diagram illustrating a method for communicating metadata and associated author identification to a plurality of users having copies of the associated file in accordance with an embodiment of the present invention;

FIG. 6 is an illustrative screen display in accordance with an embodiment of the present invention for displaying user-specific metadata in association with a file; and

FIG. 7 is a flow diagram illustrating a method for communicating user-specific metadata to a plurality of users having copies of the associated file in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. Further, the present invention is described in detail below with reference to the attached drawing figures, which are incorporated in their entirety by reference herein.

Embodiments of the present invention provide systems and methods for associating metadata with an identifier for the author thereof. Embodiments of the present invention further provide systems and methods for communicating metadata to one or more users having shared copies of the associated file, such communication being independent of communicating the associated file. Utilizing the systems and methods described herein, context is provided for each metadata value associated with a shared file as each metadata value is associated with an identifier for the author thereof. Additionally, each user of a shared file may be privy to metadata associated with a file that was not associated with the file at the time it was shared.

Accordingly, one embodiment of the present invention is directed to one or more computer-readable media having computer-executable instructions embodied thereon for performing a method for associating metadata with a file on a per-user basis. The method includes receiving metadata authored by a first user, the metadata being associated with a first copy of the file, receiving an identifier for the first user, associating the metadata with the identifier for the first user, and storing the metadata and the associated identifier for the first user in association with the first copy of the file. If desired, the method may further include communicating a second copy of the file and the metadata with the associated identifier for the first user to a second user and presenting the metadata and the associated identifier for the first user on a computing device associated with the second user.

In another embodiment, the present invention is directed to a computer-implemented method for communicating metadata associated with a file. The method includes receiving metadata associated with the file authored by a first user, each of the first user and a second user having a copy of the file, communicating the metadata to the second user, and storing the metadata in association with the second user's copy of the file. If desired, the method may further include receiving an identifier for the first user and associating the identifier for the first user with the metadata.

Embodiments of the present invention are further directed to systems and computer-readable media having computer-executable instructions for performing the methods disclosed herein.

Still further, an embodiment of the present invention is directed to one or more computer-readable media having stored thereon a data structure for associating metadata with a file on a per-user basis. The data structure includes a metadata identification field populated with metadata associated with the file and an author identification field populated with an identifier associated with the author of the metadata.

Having briefly described an overview of embodiments of the present invention, an exemplary operating environment is described below.

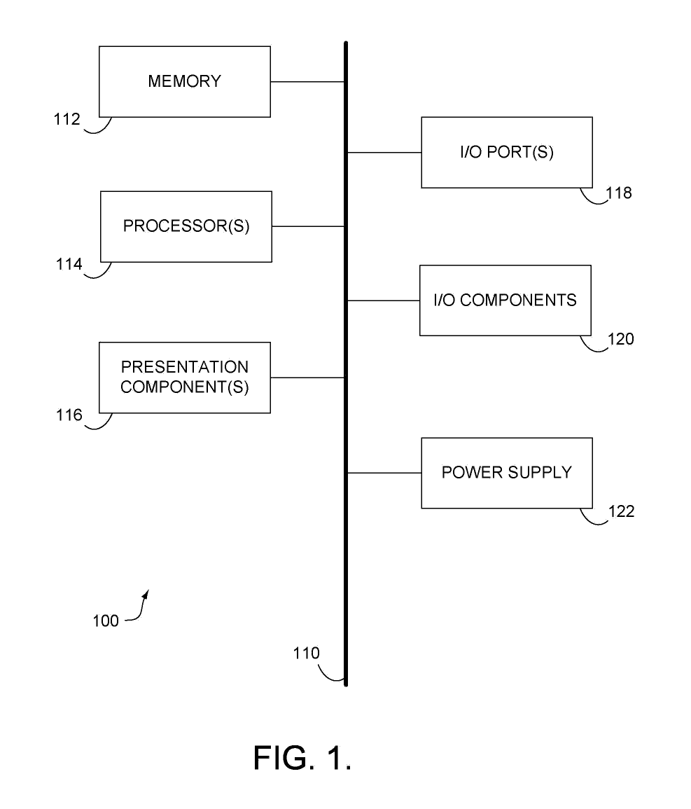

Referring to the drawings in general and initially to FIG. 1 in particular, an exemplary operating environment for implementing the present invention is shown and designated generally as computing device 100. Computing device 100 is but one example of a suitable computing environment and is not intended to suggest any limitation as to the scope of use or functionality of the invention. Neither should the computing environment 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, specialty computing devices (e.g., cameras and printers), etc. The invention may also be practiced in distributed computing environments where tasks are performed by remote processing devices that are linked through a communications network.

With reference to FIG. 1, computing device 100 includes a bus 110 that directly or indirectly couples the following elements: memory 112, a central processing unit (CPU) 114, one or more presentation components 116, input/output (I/O) ports 118, I/O components 120, an illustrative power supply 122 and a graphics processing unit (GPU) 124. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be gray and fuzzy. For example, one may consider a presentation component such as a display device to be an I/O component. Also, CPUs and GPUs have memory. The diagram of FIG. 1 is merely illustrative of an exemplary computing device that can be used in connection with one or more embodiments of the present invention. To the extent distinction is not made between such categories as “workstation,” “server,” “laptop,” “hand-held device,” etc., all are contemplated within the scope of FIG. 1 and reference to “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc. I/O ports 118 allow computing device 100 to be logically coupled to other devices including I/O components 120, some of which may be built in. Illustrative components include a microphone, joystick, game pad, satellite dish, scanner, printer, wireless device, etc.

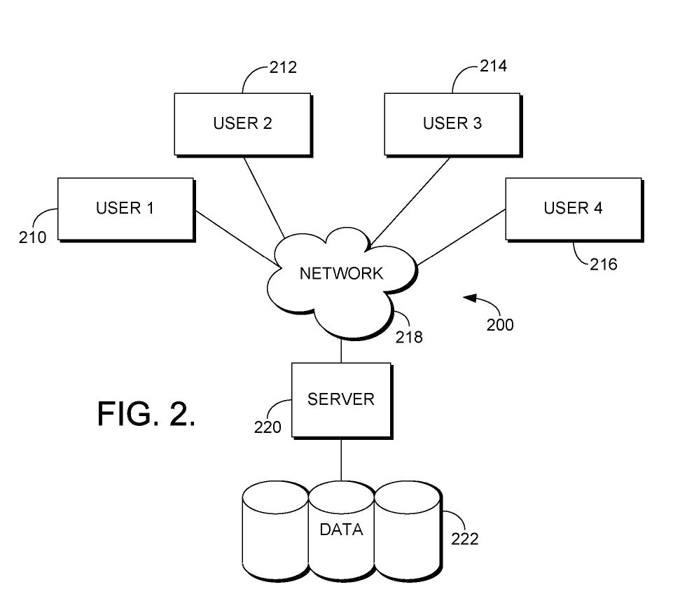

Turning to FIG. 2, a block diagram is illustrated which shows an overall system architecture 200, in accordance with an embodiment of the present invention, for associating metadata with an identifier of the author thereof and communicating metadata associated with a file among a plurality of users. It will be understood and appreciated by those of ordinary skill in the art that the overall system architecture 200 shown in FIG. 2 is merely an example of one suitable computing environment and is not intended to suggest any limitation as to the scope of use or functionality of the present invention. Neither should the overall system architecture 200 be interpreted as having any dependency or requirement related to any single component or combination of components illustrated therein.

System 200 includes a plurality of user devices 210, 212, 214, 216 in communication with one another through a network 218. In the illustrated embodiment, four user devices 210, 212, 214, and 216 are shown. It will be understood by those of ordinary skill in the art that such is merely exemplary and that the system 200 may include any number of user devices in communication with one another through a network 218. Each of the user devices 210, 212, 214, and 216 shown in FIG. 2 may be any type of computing device, such as, for example, computing device 100 described above with reference to FIG. 1. By way of example only and not limitation, each user device 210, 212, 214, and 216 may be a personal computer, desktop computer, laptop computer, handheld device, consumer electronic device, or the like. It should be noted, however, that the invention is not limited to implementation on such computing devices, but may be implemented on any of a variety of different types of computing devices within the scope of embodiments of the present invention.

In one embodiment, user devices 210, 212, 214, and 216 may be in communication with one another through a peer-to-peer relationship. In another embodiment, user devices 210, 212, 214, and 216 may be in communication with one another through a community sharing service. As such, system 200 additionally includes a general purpose computing device in the form of a server 220 in communication with each of the user devices 210, 212, 214, and 216 via network 218. Components of the server 220 may include, without limitation, a processing unit, internal system memory, and a suitable system bus for coupling various system components, including one or more databases 222 for storing information (e.g., files and metadata associated therewith), with the server 220. The server 220 typically includes, or has access to, a variety of computer readable media, for instance, databases 222. By way of example, and not limitation, computer readable media may include computer storage media and communication media. Communication media typically embodies computer readable instructions, data structures, program modules, or other data in a modulated data signal, such as a carrier wave or other transport mechanism, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer readable media.

The computer storage media, including databases 222, provide storage of computer readable instructions, data structures, program modules, and other data which may be accessed by the server 220.

The server 220 may operate in a computer network 218 using logical connections to each of the user devices 210, 212, 214, and 216. Exemplary computer networks 218 may include, without limitation, local area networks (LANs) and/or wide area networks (WANs). Such networking environments are commonplace in offices, enterprise-wide computer networks, intranets, and the Internet. When utilized in a WAN networking environment, the server 220 may include a modem or other means for establishing communications over the WAN, such as the Internet. In a networked environment, program modules or portions thereof may be stored in the server 220, in the databases 222, or on any of the user devices 210, 212, 214, and 216. For example, and not by way of limitation, various application programs may reside on the memory associated with any one or more of the user devices 210, 212, 214, and/or 216. It will be appreciated by those of ordinary skill in the art that the network connections shown are exemplary and other means of establishing a communications link between the computing devices (e.g., server 220 and user devices 210, 212, 214, and 216) may be utilized.

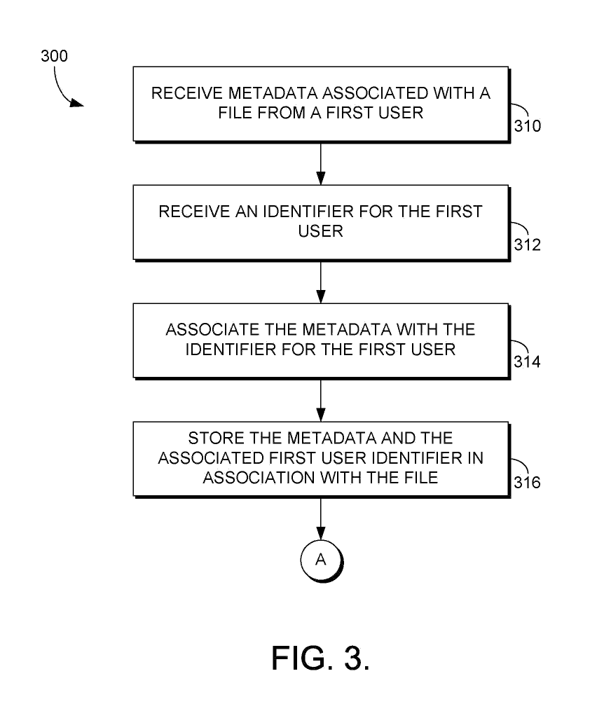

Turning to FIG. 3, a flow diagram is illustrated showing a method 300 in accordance with an embodiment of the present invention for associating metadata with a file, e.g., a text file, an image file (digital photograph, video file, etc.), or the like, on a per-user basis. Initially, as indicated at 310, metadata associated with a file is received, the metadata being authored by a first user. The metadata associated with the file may be any data about the data contained in the file including, but not limited to, keywords, captions, ratings, intents, textual notes, audio annotations, and the like. Next, as indicated at 312, an identifier for the first user, as author of the metadata, is received. The identifier for the first user should be some indicia that uniquely identifies the first user as the author of the metadata rather than merely identifying the computing device from which the subject metadata was input. In one embodiment, the identifier may be an email address associated with the first user. In another embodiment, for instance in a file sharing environment wherein a community sharing service is used, a screen name or the like may be used to identify the first user. It will be understood and appreciated by those of ordinary skill in the art that such identifiers are provided by way of example only and that any indicia that uniquely identifies the first user as the author of the metadata may be utilized within the scope of embodiments of the present invention.

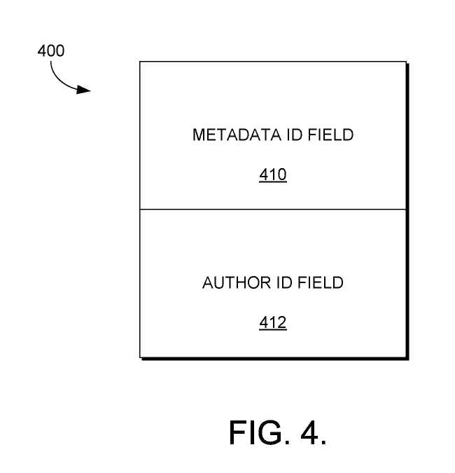

Next, as indicated at 314, the metadata and the identifier for the first user are associated with one another. In one embodiment, such association is provided by way of a data structure. Such a data structure 400 in accordance with an embodiment of the present invention is illustrated in FIG. 4. The data structure 400 includes a metadata identification field 410 configured to receive metadata associated with the file and an author identification field 412 configured to receive an identifier associated with the author of the metadata.

Referring back to FIG. 3, the metadata and the associated first user identifier are subsequently stored in association with the file, as indicated at 316.

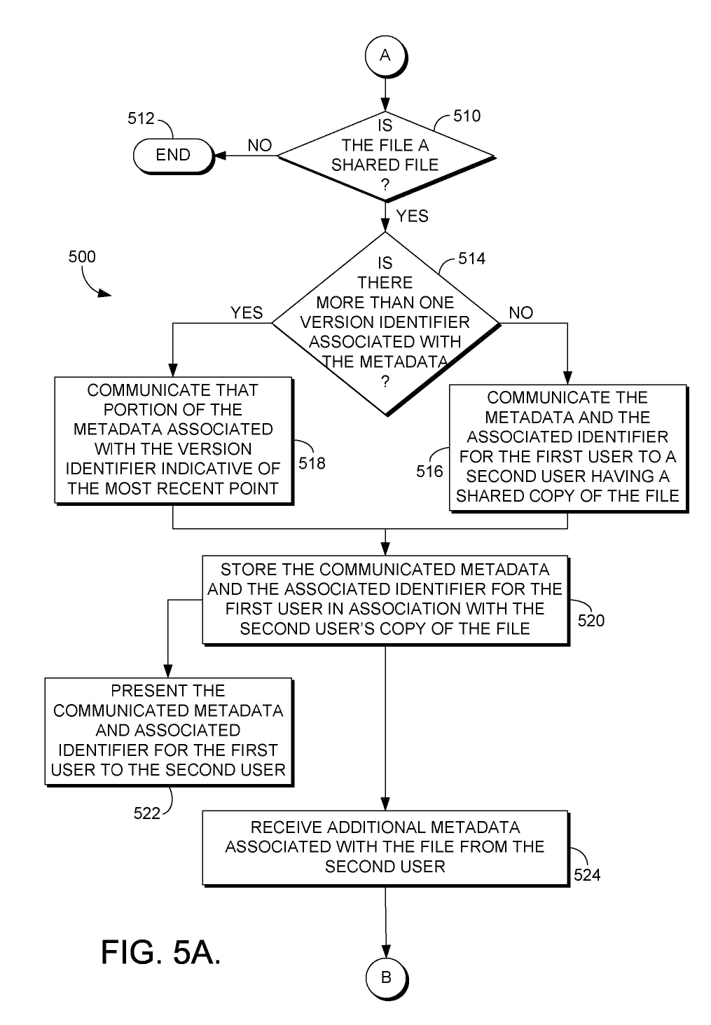

Turning now to FIGS. 5A and 5B, a flow diagram is illustrated that shows a method 500, in accordance with an embodiment of the present invention, for communicating metadata and associated author identification to a plurality of users having copies of the associated file. In one embodiment, metadata is received and associated with an identifier for the author thereof in accordance with the method 300 of FIG. 3 prior to initiation of the method 500 of FIG. 5. Once the metadata is received and associated with an identifier for the author thereof, it is determined whether the file having the metadata and associated author/user identifier associated therewith is a shared file. This is indicated at 510. If it is determined that the file is not a shared file, the method is terminated, as indicated at 512. If it is determined at 510 that the file is a shared file, it is next determined whether there is more than one version identifier associated with the metadata, as indicated at block 514. More than one version identifier may be associated with the metadata if, for instance, the first user input metadata for association with a file (e.g., a “5 star” rating) and at a later point in time, altered that metadata (e.g., changed the “5 star” rating to a “4 star” rating). Upon communication of the metadata to another user, as more fully described below, it may be desirable to communicate only the metadata that was input at the most recent point in time (i.e., the “4 star” rating in the above example). The inclusion of version identifiers in association with the metadata associated with a file aids in insuring this result. Version identifiers may be provided, by way of example only and not limitation, via time stamping, sequence numbering, and the like.

If it is determined at block 514 that there is not more than one version identifier associated with the metadata, the metadata and the associated identifier for the author/user is communicated to at least a second user having a shared copy of the file, as indicated at block 516. If, however, it is determined at block 514 that there is more than one version identifier associated with the metadata, only that portion of the metadata that is associated with the version identifier indicative of the most recent point in time is communicated to the second user. This is indicated at block 518. In either event, communication of the metadata may occur via a push model or a pull model in accordance with embodiments of the present invention. For instance, if the file sharing occurred through a peer-to-peer relationship, any changes to a shared file may be automatically communicated to all shared file recipients, without the need for additional user intervention. However, if the file sharing occurred through a community file sharing service, a server may periodically query each of the computing devices associated therewith to determine if any metadata changes have occurred to any of the files stored in association therewith. If it is determined that metadata changes have occurred, the server may then determine the identity of all users who were recipients of the shared file and communicate the metadata change to each of them. Any and all such variations are contemplated to be within the scope of embodiments of the present invention.

It should be noted that in accordance with method 500, the metadata and associated user/author identifier are communicated to all shared file recipients independent of the file itself. That is, a copy of the file need not simultaneously be communicated with the metadata and user/author identification information. As such, once received by the second user, the communicated metadata and the associated identifier for the author/user thereof is stored in association with the second user's copy of the file, that is, the copy of the file the second user received upon the original file sharing. This is indicated at 520.

If desired, the metadata and associated user/author identifier may subsequently be presented to the second user, as indicated at block 522. Typically, such presentation comprises displaying the metadata and associated author/user identifier on a display device associated with the second user's computing device. However, other types of presentation, such as an audible presentation, may also be provided within the scope of embodiments of the present invention.

Next suppose that the second user desires to add his or her own metadata to the shared file. In this instance, the additional metadata to be associated with the file is received from the second user, as indicated at 524. Subsequently, an identifier for the second user, as author of the additional metadata, is received, as indicated at 526. As with the identifier for the first user, the identifier for the second user as author of the additional metadata is some indicia that uniquely identifies the second user, e.g., an email address, screen name, or the like. Next, the additional metadata and the identifier for the second user are associated with one another, e.g., using a data structure such as the data structure 400 shown in FIG. 4, as indicated at 528. Subsequently, as indicated at 530, the additional metadata and associated identifier for the second user (as author thereof) is stored in association with the second user's copy of the file.

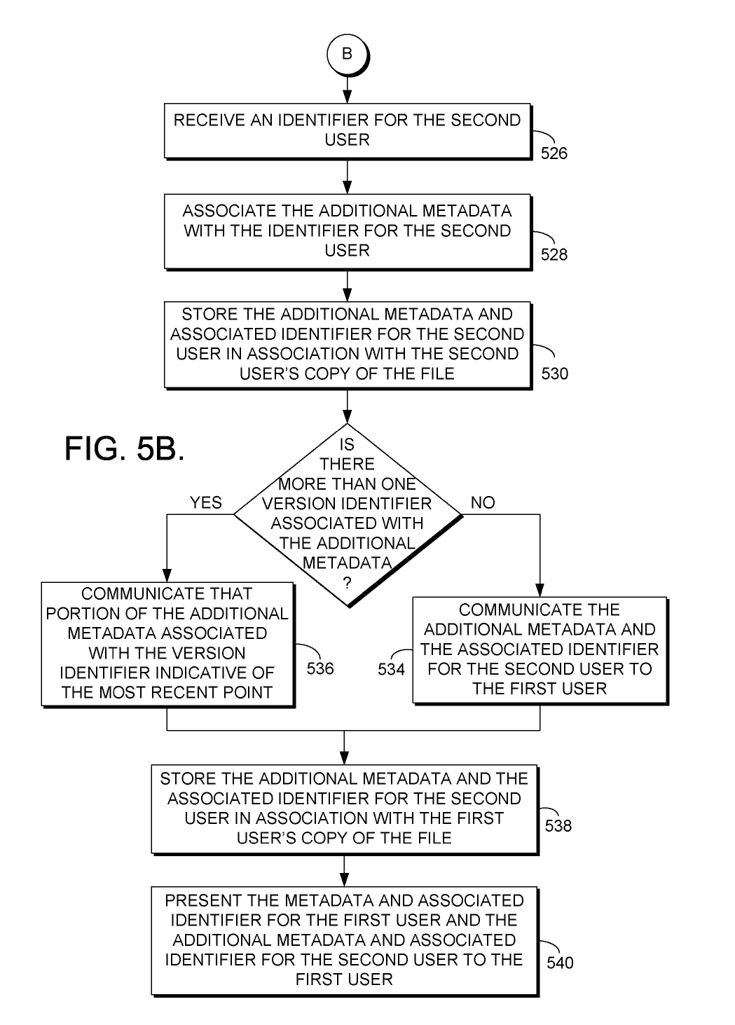

As the file with which the additional metadata has been associated has been determined to be a shared file (at 510), it is next determined whether there is more than one version identifier associated with the additional metadata, as indicated at 532. If it is determined that there is not more than one version identifier associated with the additional metadata, the additional metadata and the associated identifier for the second user (as author thereof) is subsequently communicated to the first user, as indicated at 528. If, however, it is determined that there is more than one version identifier associated with the additional metadata, only that portion of the additional metadata that is associated with the version identifier indicative of the most recent point in time is communicated to the first user. This is indicated at 536. Again, the metadata is communicated independent of the associated file and may be communicated by virtue of a push model, a pull model, or any combination thereof. Subsequently, the communicated additional metadata and the associated identifier for the second user (as author thereof) is stored in association with the first user's copy of the file. This is indicated at 538. If desired, the metadata and associated identifier for the first user (as author thereof) and the additional metadata and associated identifier for the second user (as author thereof) may be presented to the first user, as indicated at block 540. An exemplary screen display for displaying metadata associated with a shared file on a per-user basis is illustrated in FIG. 6.

The screen display 600 includes a file presentation area 610 and a metadata presentation area 612. The file presentation area 610 is configured to display the content of the file, e.g., the photograph or text. The metadata presentation area 612 includes a file originator/author presentation area 614 and a per-user metadata presentation area 616. Note that the per-user metadata presentation area 616 includes the author identifier for two users with the metadata each user has authored being displayed respectively in association therewith. It will be understood and appreciated by those of ordinary skill in the art that the screen display 600 shown in FIG. 6 is merely an example of one suitable screen presentation and is not intended to suggest any limitation as to the scope of use or functionality of the present invention.

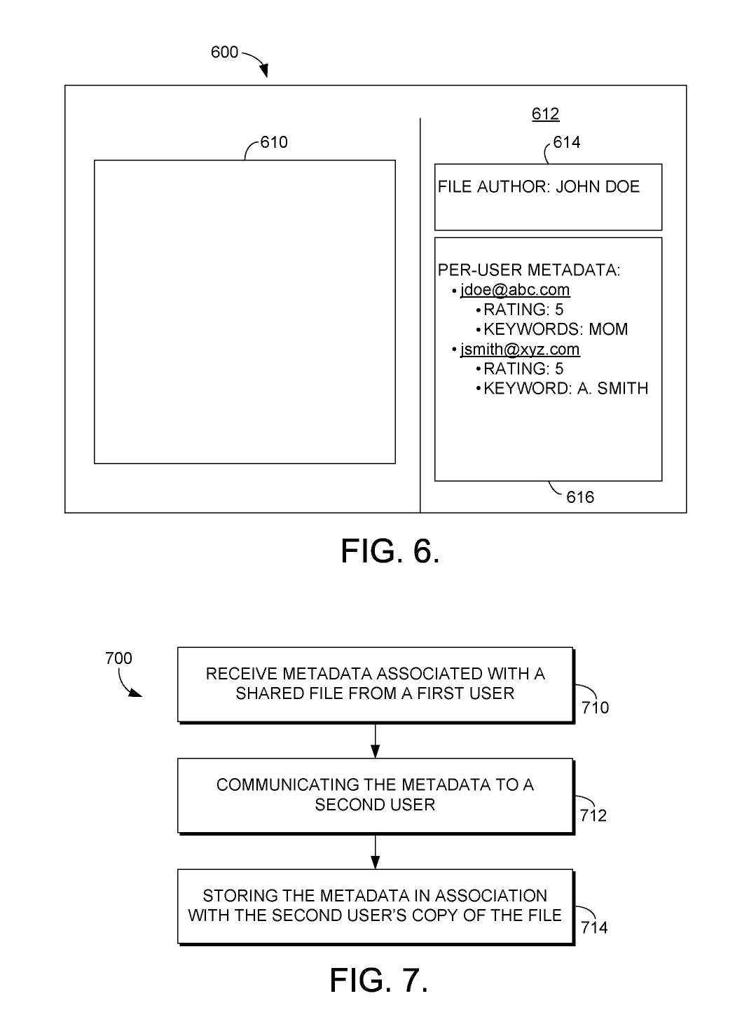

Referring now to FIG. 7, a flow diagram illustrating a method 700, in accordance with an embodiment of the present invention, for communicating metadata to a plurality of users having copies of the associated file is shown. Initially, as indicated at 710, metadata associated with a shared file is received, the metadata being authored by a first user. Subsequently, the metadata is communicated to a second user, as indicated at 712, without simultaneous communication of the associated file. Such communication may occur via a push model, a pull model, or any combination thereof in accordance with embodiments of the present invention. For instance, if the file sharing occurred through a peer-to-peer relationship, any changes to a shared file may be automatically communicated to all shared file recipients, without the need for additional user intervention. However, if the file sharing occurred through a community file sharing service, a server may periodically query each of the computing devices associated therewith to determine if any metadata changes have occurred to any of the files stored in association therewith. If it is determined that metadata changes have occurred, the server may then determine the identity of all users who were recipients of the shared file and communicate the metadata change (or that portion of the changed metadata associated with a version identifier indicative of the most recent point in time, as described hereinabove) to each of them. Any and all such variations are contemplated to be within the scope of embodiments of the present invention. The metadata is subsequently stored in association with the second user's copy of the file, as indicated at 714.

Alternative embodiments and implementations of the present invention will become apparent to those skilled in the art to which it pertains upon review of the specification, including the drawing figures. Accordingly, the scope of the present invention is defined by the appended claims rather than the foregoing description.

What is claimed is:

1. One or more computer-readable media having computer-useable instructions embodied thereon for performing a method for associating metadata with a file on a per-user basis, the method comprising:
receiving metadata authored by a first user, the metadata being associated with a first copy of the file;
receiving an identifier for the first user;
associating the metadata with the identifier for the first user; and
storing the metadata and the associated identifier for the first user in association with the first copy of the file.

2. The computer-readable media of claim 1, wherein the method further comprises communicating a second copy of the file and the metadata with the associated identifier for the first user to a second user.

3. The computer-readable media of claim 2, wherein the method further comprises presenting the metadata and the associated identifier for the first user on a computing device associated with the second user.

4. The computer-readable media of claim 2, further comprising determining if there is more than one version identifier associated with the metadata, wherein if it is determined that there is more than one version identifier associated with the metadata, communicating the second copy of the file and the metadata comprises communicating the second copy of the file and that portion of the metadata that is associated with the version identifier indicative of the most recent point in time.

5. The computer-readable media of claim 2, wherein the method further comprises:
receiving additional metadata authored by the second user, the additional metadata being associated with the second copy of the file;
receiving an identifier for the second user;
associating the additional metadata with the identifier for the second user; and
storing the additional metadata with the associated identifier for the second user in association with the second copy of the file.

6. The computer-readable media of claim 5, wherein the method further comprises:
communicating the additional metadata with the associated identifier for the second user to the first user; and
storing the additional metadata with the associated identifier for the second user in association with the first copy of the file.

7. The computer-readable media of claim 6, wherein the method further comprises presenting the metadata and the associated identifier for the first user and the additional metadata and the associated identifier for the second user on a computing device associated with the first user.

8. The computer-readable media of claim 6, further comprising determining if there is more than one version identifier associated with the additional metadata, wherein if it is determined that there is more than one version identifier associated with the additional metadata, communicating the additional metadata comprises communicating that portion of the additional metadata that is associated with the version identifier indicative of the most recent point in time.

9. The computer-readable media of claim 1, wherein the file comprises one of an image file and a video file.

10. A computer-implemented method for communicating metadata associated with a file, the method comprising:
receiving metadata associated with the file authored by a first user, each of the first user and a second user having a copy of the file;
communicating the metadata to the second user; and
storing the metadata in association with the second user's copy of the file.

11. The method of claim 10, further comprising determining if there is more than one version identifier associated with the metadata, wherein if it is determined that there is more than one version identifier associated with the metadata, communicating the metadata to the second user comprises communicating that portion of the metadata that is associated with the version identifier indicative of the most recent point in time.

12. The method of claim 10, further comprising:
receiving an identifier for the first user; and
associating the identifier for the first user with the metadata.

13. The method of claim 12, wherein communicating the metadata to the second user comprises communicating the metadata and the associated identifier for the first user to the second user, and wherein storing the metadata comprises storing the metadata and the associated identifier for the first user in association with the second user's copy of the file.

14. The method of claim 13, further comprising presenting the metadata and the associated identifier for the first user on a computing device associated with the second user.

15. The method of claim 10, further comprising:
receiving additional metadata associated with the file authored by the second user;
communicating the additional metadata in association with an identifier for the second user to the first user; and
storing the additional metadata and the associated identifier for the second user in association with the first user's copy of the file.

16. The method of claim 15, further comprising presenting the metadata and the associated identifier for the first user and the additional metadata and the associated identifier for the second user on a computing device associated with the first user.

17. The method of claim 15, further comprising determining if there is more than one version identifier associated with the additional metadata, wherein if it is determined that there is more than one version identifier associated with the additional metadata, communicating the additional metadata comprises communicating that portion of the additional metadata that is associated with the version identifier indicative of the most recent point in time.

18. The method of claim 10, wherein the file comprises one of an image file and a video file.

19. One or more computer-readable media having computer-useable instructions embodied thereon for performing the method of claim 10.

20. One or more computer-readable media having stored thereon a data structure for associating metadata with a file on a per-user basis, the data structure comprising:
a metadata identification field populated with metadata associated with the file; and
an author identification field populated with an identifier associated with the author of the metadata.
